(19) United States
(12) Patent Application Publication
(10) Pub. No.: US 2014/0097787 A1
(43) Pub. Date: Apr. 10, 2014

(54) Active battery management system for a battery pack

(71) Applicant: Yi-Ming Lin, Taipei (TW)

(72) Inventor: Yi-Ming Lin, Taipei (TW)

(21) Appl. No.: 13/647,400

(22) Filed: Oct. 9, 2012

(51) Int. Cl. H02J 7/00

(52) U.S. Cl. 320/103

(57) ABSTRACT

A battery management system (BMS) for actively balancing the voltages and capacities of battery cells in a serial battery pack is provided. The BMS uses an array of synchronized voltage monitors to detect underperforming cells in the battery pack, and employs high speed parallel energy transfers to actively balance the voltages and capacities of cells which exceeds a preset threshold limit against the average voltage and capacity of the remaining cells in the battery pack as an integrated unit. The BMS works both in charging and discharging operations, and is particularly useful for improving the overall performance of the battery packs in applications which require frequent high energy output rate, deep discharging, and fast charging operations.

### BACKGROUND OF THE PRESENT INVENTION

1. Field of the Present Invention

The present invention relates to battery management systems and more particularly to an active battery management system for a battery pack.

2. Description of Related Art

It is well known that the performance of a lead-acid battery cell can be affected by various factors, such as production variances, different ageing characteristics, uneven temperature distribution in a battery pack, etc. It is very difficult to obtain or maintain a uniform voltage and/or capacity across the battery cells in a battery pack. Consequently, in certain applications, the performance of the battery pack could deteriorate quickly over a short period of time when one of the cells becomes underperforming in a battery pack. The underperforming cell acts as a limiting factor and prevents the battery pack from reaching full voltage or full capacity during charging operation. The underperforming cell also stops the battery pack from providing full voltage or full capacity during discharging operation. Existing battery management system (BMS) is known to be useful for minimizing the performance differences between the cells, so as to improve the overall performance of the battery pack. However, conventional battery management systems generally passively balance the voltage and capacity by using a resistance load to discharge the excess amount of energy in the underperforming cells during charging operation, which wastes energy and also causes undesirable local temperature rise in neighboring cells. As to known active balancing methods, such as serial DC-DC fly-back converters, they generally suffer slow response time, and are inefficient for handling demanding applications, such as managing battery pack for driving a motor of electrical vehicle.

The goal of the present invention is to provide an improved BMS which is capable of minimizing the known problems associated with the conventional battery management systems.

### SUMMARY OF THE PRESENT INVENTION

It is therefore one object of the present invention to provide a battery management system (BMS) which is an active balancing system which employs an array of synchronized monitors to obtain the voltage of each battery cell individually in a battery pack. The voltage data are conveyed instantaneously and continuously to a central processing unit. The voltages and capacities of the battery cells in a battery pack are actively balanced during both charging and discharging operations. The BMS optimizes the performance of the battery pack with a minimal amount of energy waste, an increased efficiency, an improved overall voltage and capacity, and an increased battery pack life. Based on the voltage data obtained by the synchronized monitors, underperforming battery cells in the pack are instantaneously identified. High speed parallel energy transfers are employed to instantaneously and actively balance the voltages and capacities in the underperforming cells, and bring them to an equalized state with the other cells in the pack continuously. The system works in both charging and discharging operations. The BMS is particularly useful for improving the overall performance of the battery packs for applications which require frequent varying high energy output rates, relatively deep discharging, and fast charging operations, such as the battery packs for electric vehicles.

The above and other objects, features and advantages of the present invention will become apparent from the following detailed description taken with the accompanying drawings.

### BRIEF DESCRIPTION OF THE DRAWINGS

FIG. 1 depicts an active battery management system for a serial battery pack of the present invention;

FIGS. 2A and 2B depict the differences in types of active balancing methods;

FIG. 3 depicts an energy transfer diagram;

FIG. 4 depicts the directions of active energy transfers;

FIG. 5 depicts the timing and method of balancing a battery cell by a charging process;

FIG. 6 depicts the timing and method of balancing a battery cell by a discharging process;

FIG. 7 depicts the opportune direction of energy transfer;

FIG. 8 depicts the individual voltage monitor for each battery cell in a battery pack; and

FIG. 9 is a flow chart of the operation system algorithm of the BMS.

### DETAILED DESCRIPTION OF THE PRESENT INVENTION

Reference will now be made in detail to the preferred embodiments of the BMS in present invention. Examples of the elements are illustrated in the accompanying drawings. While the present invention will be described in conjunction with the preferred embodiments, it will be understood that they are not intended to limit the present invention to these embodiments. It will be recognized by one of ordinary skill in the art that the present invention may be practiced with obvious modifications to the disclosed specific details.

Parallel Power Transfer

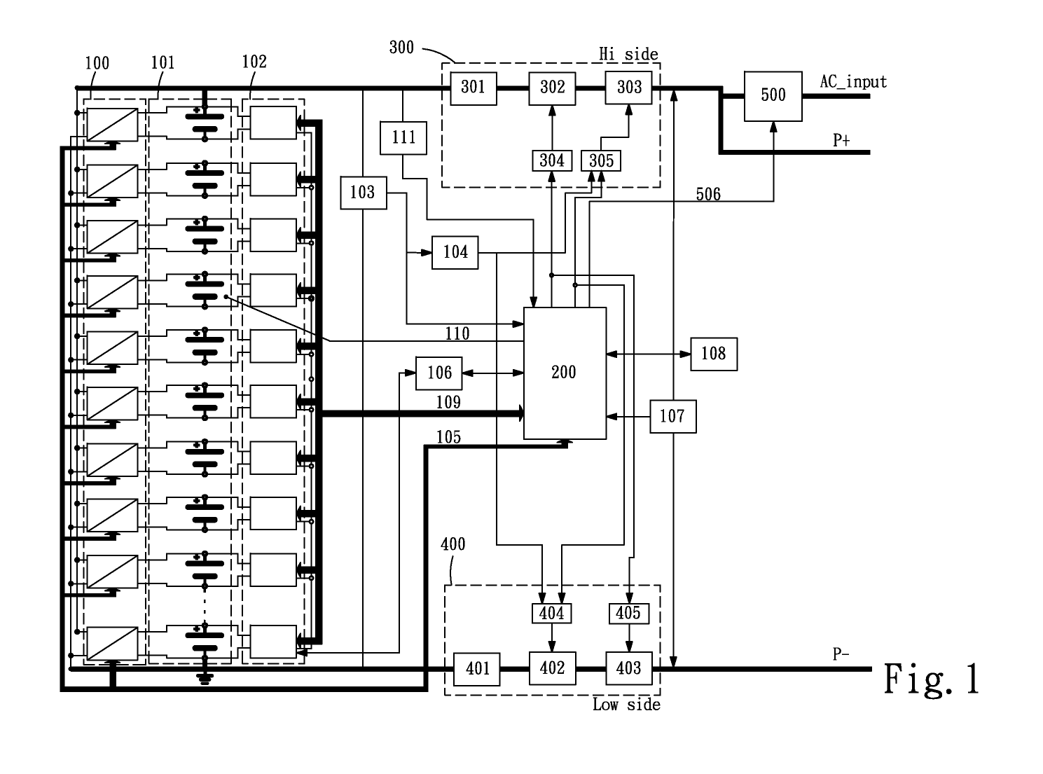

FIG. 1 illustrates an active battery management system for a serial battery pack. The battery management system has an array of power transfer units 100. The power transfer units are parallel integrated. Each of the power transfer units 100 is connected individually to one of the battery cells 101 in the battery pack. The voltage of each cell 101 is individually monitored by an array of synchronized voltage monitors 102. The voltage monitors 102 communicate with a central control unit 200 via a balance control 105. The temperature of the battery pack is monitored by a temperature gauge 110. The temperature is also communicated to the central control unit 200. In accordance to a predetermined voltage differential limit among the cells, the balance control unit 105 instantly determines whether there is a cell out of balance with the average cell voltage of the battery pack. Once the voltage differential detected to be greater than the limit, an active balancing operation kicks in. The active balancing decision is carried out by two loop controllers. A Hi-Side loop controller 300 is coupled to the positive electrode of the battery pack, and a Low-Side loop controller 400 is coupled to the negative electrode of the battery pack. Each of the loop controllers 300, 400 is composed of a current sensor 301, 401, a charge loop switch 302, 402, a discharge loop switch 303, 403, a charge switch gate driver 304, 404, and a discharge switch gate driver 305, 405. The loop controllers 300, 400 carry out the active balancing operation decisions from the central control unit 200 by sending out individual command signal to a corresponding power transfer unit 100 to start transferring energy between the underperforming cell and the remaining cells in the battery pack. All the remaining cells in the battery pack function as one integrated unit in the balancing process. In essence, the active balancing operation are carried out by the parallel power units which transfer the energy among the cells in the battery pack, so as to maintain an equalized voltage and capacity among the cells. This operation is critical for avoiding exacerbating the underperforming cells in a battery pack, prolonging the lifecycles of the battery pack, and allows the full voltage and capacity of the battery pack available for use.

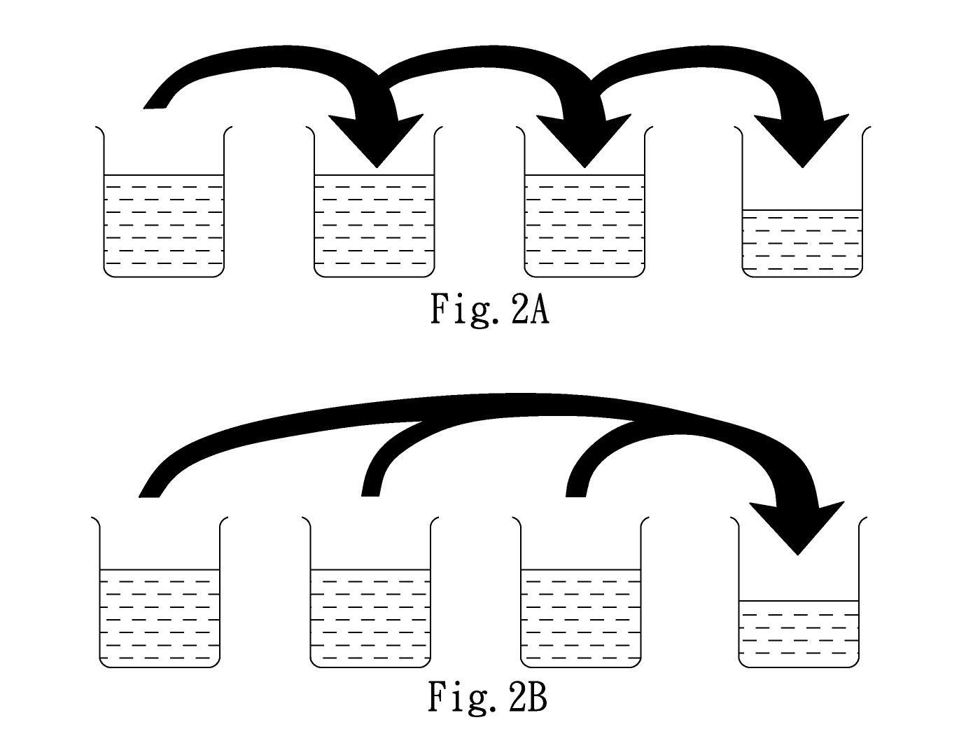

FIG. 2A illustrates that conventional battery management systems using serial DC-DC fly-black converters suffer from a slow stepwise energy transfer process. The stepwise process is inefficient for the demanding application conditions requiring high energy output rate and rapid charging rate. In contrast, FIG. 2B illustrates that the present invention employs integrated parallel power transfer units to work together as a single unit for active balancing the battery cells. The parallel power transfer units have a rapid response time, which meets the demanding high performance applications, such as driving motors of electrical vehicles which would require frequent steep electrical energy output rate, i.e., frequent deep discharging from the battery pack, and shortened charging operation.

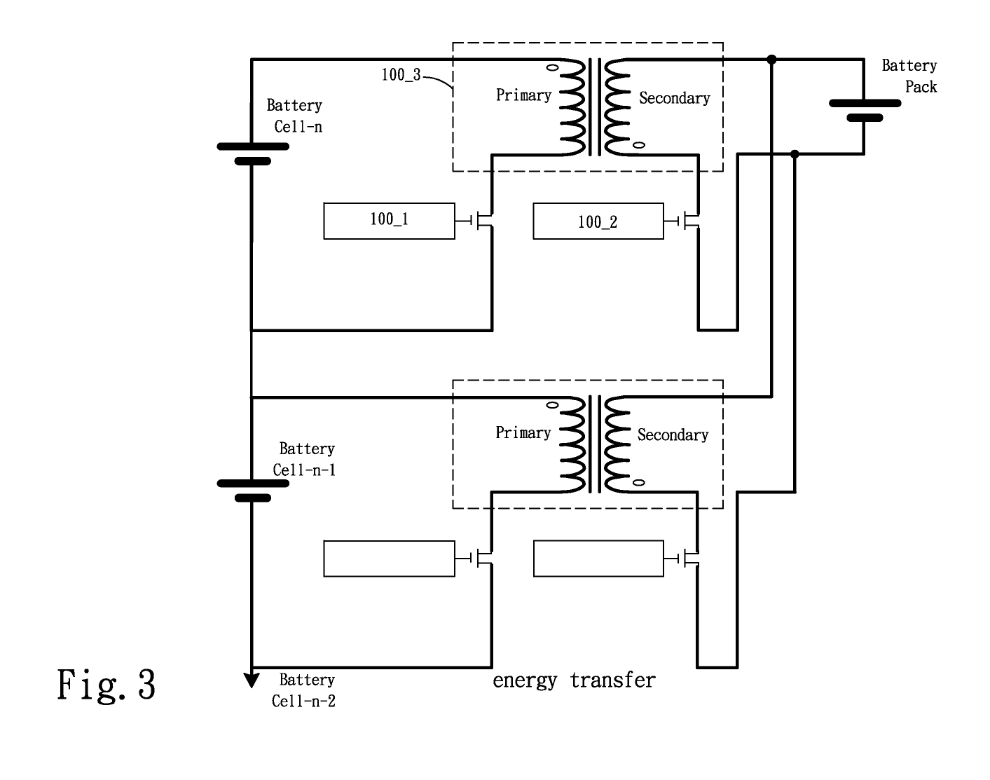

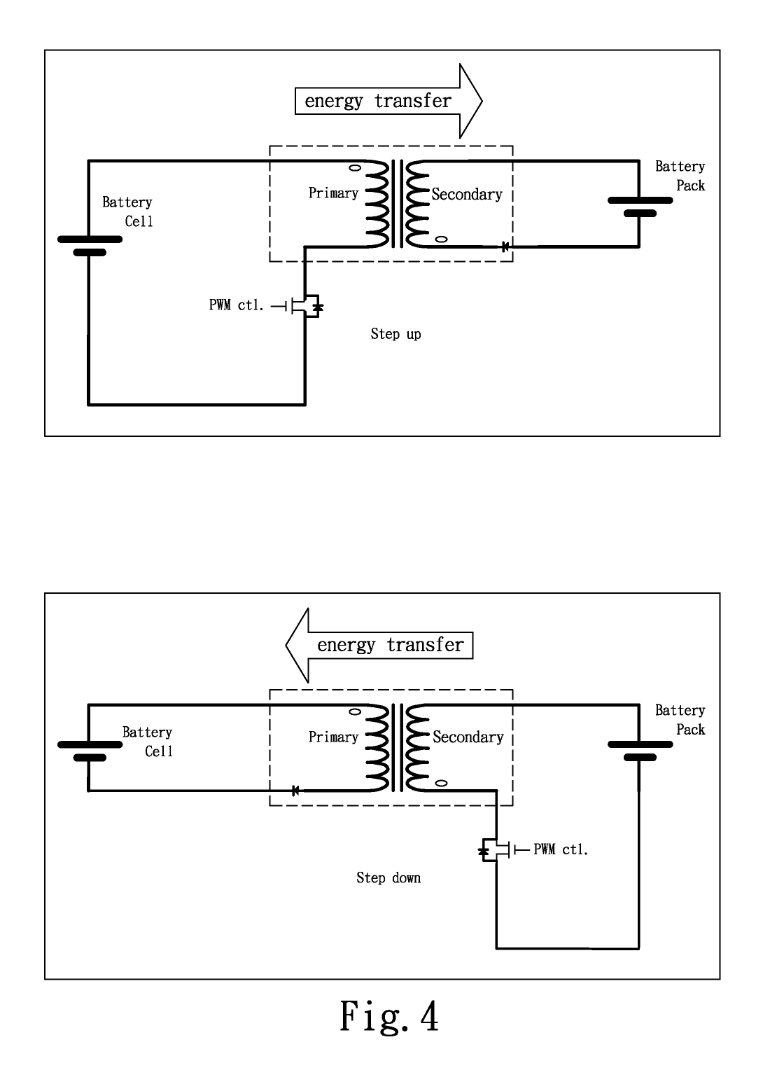

FIG. 3 illustrates further details of the parallel energy transfer units 100 in the BMS of the present invention. Each energy transfer unit is a DC-DC converter comprising a discharge type energy transfer control 100-1 and a charge type energy transfer control 100-2. During a charging operation, since an underperforming battery cell would reach an increased voltage limit sooner than the other cells, a discharge type energy transfer control 100-1, such as a PWM controller, actively transfers excessive energy from the underperforming battery cell to the remaining cells in a battery pack as an integrated unit, and therefore reduces the voltage of the underperforming cell to be equalized with the other cells in the battery pack. On the other hand, during a discharging operation, a charge type energy transfer control 100-2 actively transfers energy from the remaining battery cells in a battery pack as an integrated unit via a PWM controller into an underperforming battery cell, which has a tendency to reach a reduced voltage limit faster than the other cells, and the active energy transfer raises the voltage of the underperforming cell to an equalized state with the other cells in the battery pack. FIG. 4 further illustrates that, during charging operation, a PWM controller is used as energy transfer control to step down the voltage of the underperforming cell by transferring the energy to the remaining cells in the battery pack as an integrated unit. Whereas, during discharging operation, a PWM controller are used as energy transfer control to step up the voltage of underperforming cell by transferring the energy from the remaining cells in the battery pack as an integrated unit to the underperforming cell. Comparing to conventional balancing operations, the DC-DC converter in the BMS of the present invention transfers the energy among the cells with greatly improved efficiency and negligible amount of thermal energy loss. In general, the BMS has a high efficiency of energy transfer of greater than 90%, and an energy loss of less than 10%.

Opportune Direction of Energy Transfer

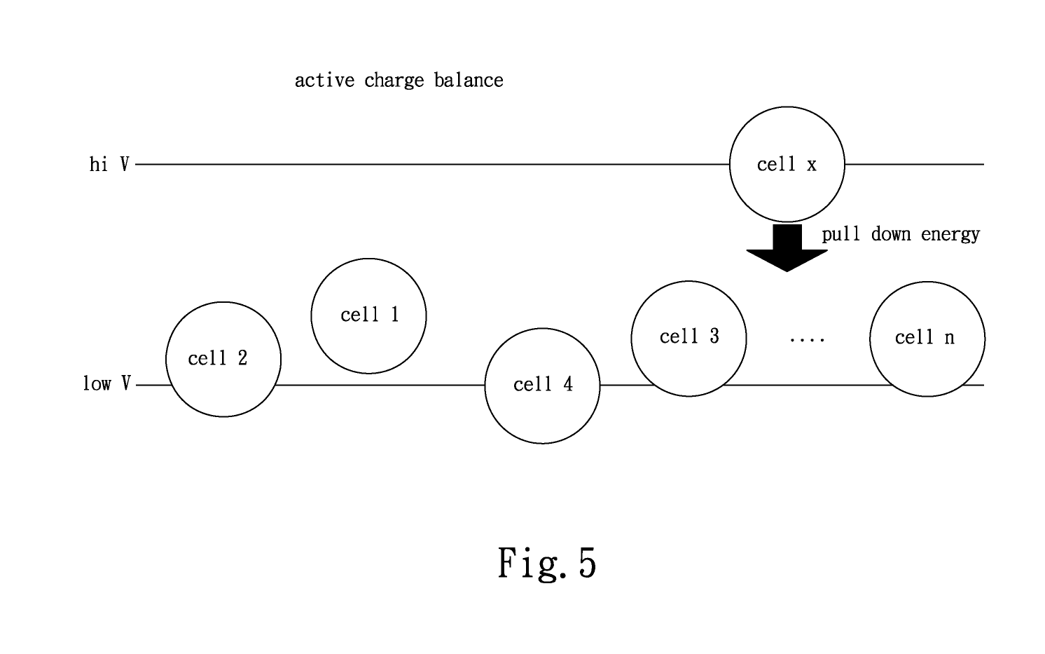

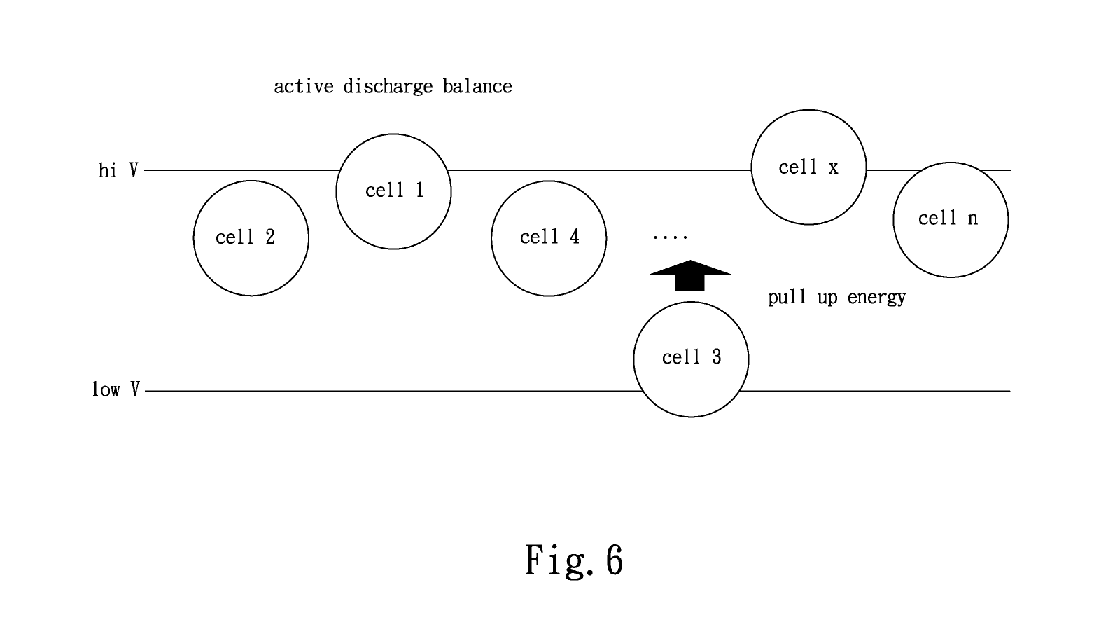

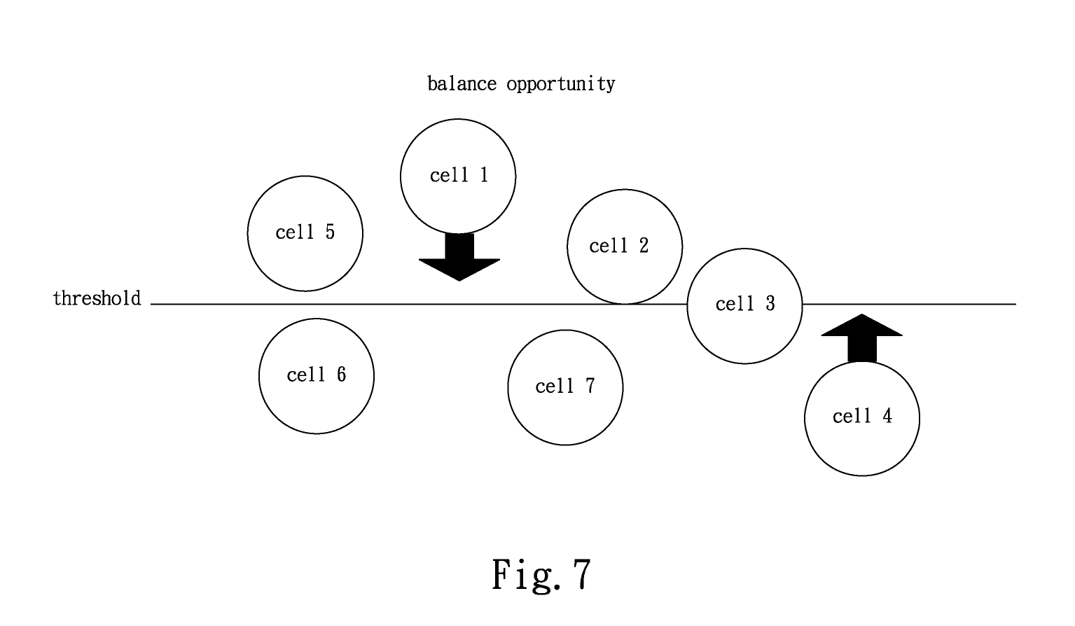

FIGS. 5 and 6 illustrate that while majority of the battery cells in a battery pack have voltages in a close range, i.e., around an average voltage value, during charging and discharging operations. Some cells would gradually deteriorate faster than average over time to the point that the cells become performance limiting factor in the battery pack. During charging operation, the underperforming cells would reach their charging capacities earlier than the remaining cells in the battery pack, and manifested as cells having higher voltages. Once the voltages of the underperforming cells reach a threshold value, the charging operation of the remaining cells in the battery pack would be impeded. To the contrary, during discharging operation, since the underperforming cells would have smaller capacities and faster drop in their voltages, their discharging process must be slowed down by actively transferring energy into them from the remaining cells in the battery pack. Without the managed discharging process, the battery pack would prematurely reach the preset voltage limit and becomes unable to provide the full capacity. FIG. 7 illustrates a basic principle of the BMS of the present invention: opportune direction of energy balance transfer. That is the energy transferring to and/or from battery cells is not particularly fixed to charging or discharging operations. Whenever the cells are detected to be over a preset threshold limit over an average voltage value in either direction, the BMS is capable to instantaneously and actively balance the cells which are outside the threshold limit, so as to continuously equalize the voltages and capacities of all the cells to an acceptable close small range about the average voltage and capacity of all the cells in the battery pack in any opportune direction.

Synchronized Voltage Monitor

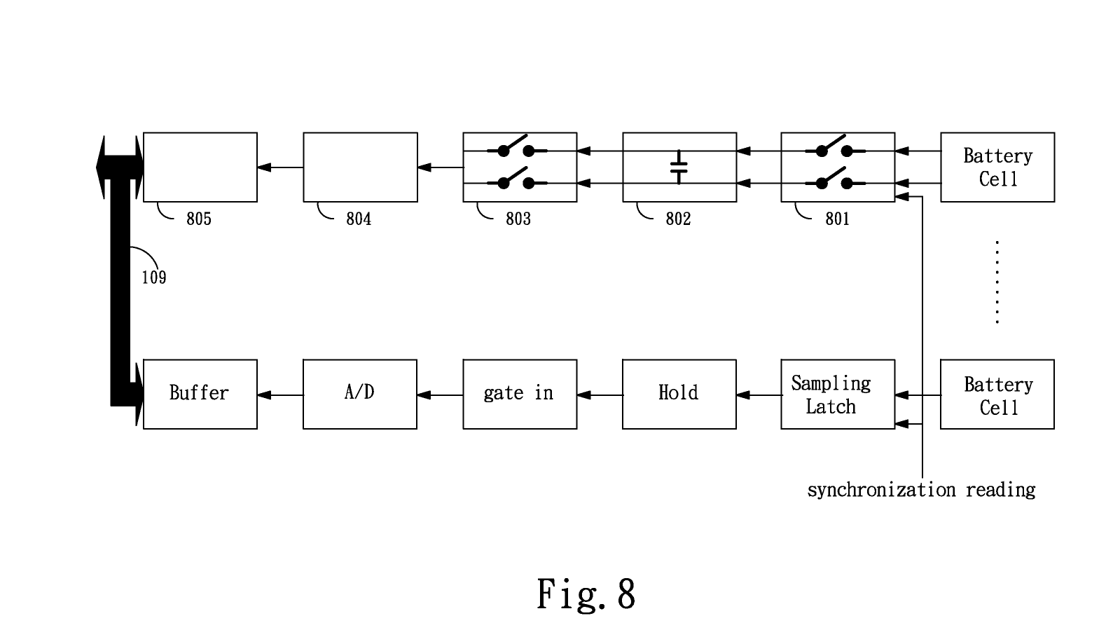

The present invention uses an array of synchronized voltage monitors. FIG. 8 illustrates the components in the synchronized voltage monitor. Each monitor has a synchronized reading interface 106 attached to the battery cell individually. An array of sampling-latches 801 reads the voltage of each cell simultaneously, and stores the analog data in voltage-holds 802. The analog data in each voltage-hold 802 is then processed through a gate-in latch 803, transformed by an analog-to-digital (A/D) converter 804 to digital data, and saved in a buffer 805. The data is then communicated from the buffer 805 to the central control unit 200 for the active balancing decisions for each cell 101 in the battery pack. The synchronized voltage monitors are designed to avoid data corruption caused by transient electromagnetic interference, which is a common problem from electric motor under load. By reading the voltages of the battery cells simultaneously, the voltage differential ΔV between the battery cells are not affected by the transient electromagnetic interference, because the level of interference to each cell is kept at the same level. Accurate voltage data are absolutely critical for the central control unit 200 to make correct active balancing decisions.

Battery Management Operation Flow Chart

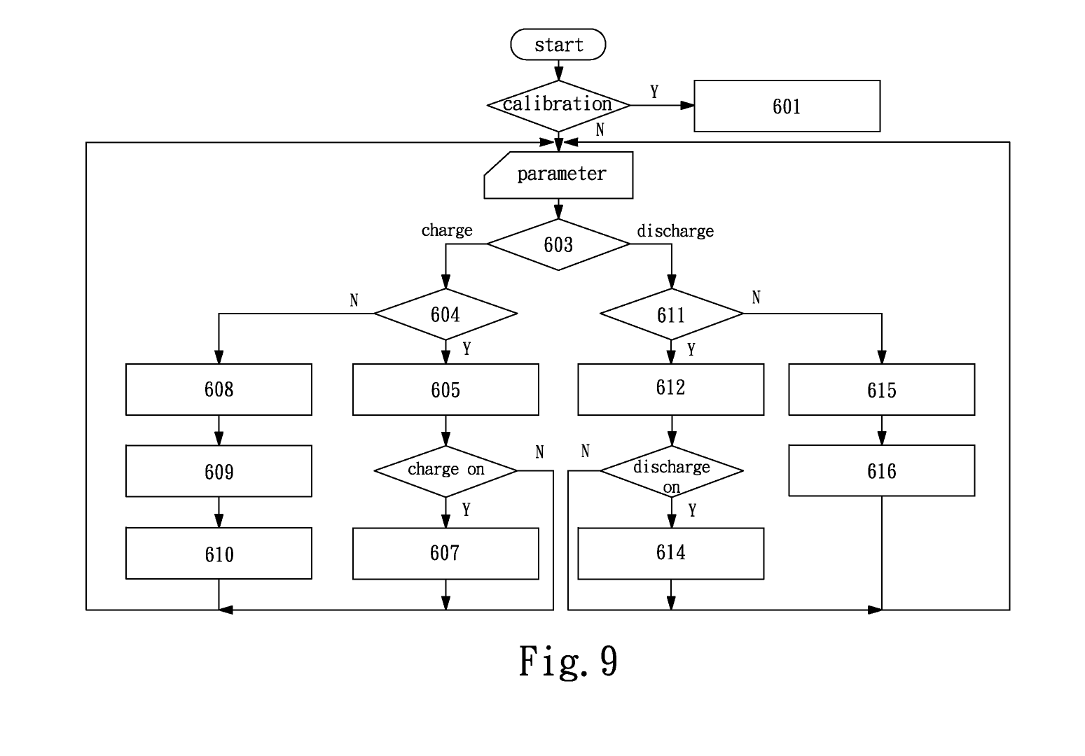

FIG. 9 illustrates an operation flow chart of the BMS of the present invention. In order to ensure data accuracy, all the data are automatically calibrated 601 initially. Current sensors 301, 401 check whether the battery pack 603 is in charging or discharging operation. In charging operation, the synchronized voltage monitors 102 continuously communicate the voltage data to the central control unit 200 for determining whether there is any underperforming cell against the preset upper limit of the threshold voltage relative to the average voltage value of the average cells in the battery pack 604. Once the threshold limited is exceeded, the charge loop switch 302, 402 stops the charging operation 605 of the underperforming cells, until their voltages become within the threshold limit again, then the charging operation is resumed 607. The cells having highest voltage or lowest capacity are constantly being monitored and identified 608. The active balance process is executed to transfer energy from the cell to the average cells as an integrated unit in the battery pack via the parallel power transfer units 609, so as to equalize the voltages of the cells 610. On the other hand, when the battery pack is in discharging operation, the synchronized voltage monitor 102 continuously communicate the voltage data to central the control unit 200 to determine whether there is any underperforming cell against the preset lower limit of the threshold voltage relative to the average voltage value of the average cells in the battery pack 611. Once the threshold limited is exceeded, the discharge loop switch 303, 4023 stops the discharging operation 612 of the underperforming cells, until their voltages become within the threshold limit again, then the discharging operation is resumed 614. The cells having lowest voltage or highest capacity are constantly being monitored and identified 615. The active balance process is executed to transfer energy from the average cells as an integrated unit in the battery pack via the parallel power transfer units 616, so as to equalize the voltages of the cells.

While the present invention has been described in terms of preferred embodiments, those skilled in the art will recognize that the present invention can be practiced with modifications within the spirit and scope of the appended claims.

What is claimed is:

1. An active battery management system for a battery pack comprising serial battery cells, the battery management system comprising:
(A) an array of synchronized voltage monitors for measuring each of the cell voltages in the battery pack individually, and the voltage data are communicated to a central control unit via a balance control;
(B) a hi-side loop controller, which is coupled to a positive electrode of the battery pack;
(C) a low-side loop controller, which is coupled to a negative electrode of the battery pack; and
(D) an array of power transfer units, which are integrated in parallel and are connected individually to the cells in the battery pack;
wherein the central control unit actively balance the voltages and capacities of underperforming cells which exceeds a preset threshold limit against the average voltage and capacity of the remaining cells in the battery pack; and
wherein the loop controllers carry out the active balancing operations by sending out individual command signal to a corresponding power transfer unit to transfer energy between the underperforming cell and the remaining cells in the battery pack as an integrated unit.

2. The active battery management system of claim 1, wherein the battery management system has a high energy transfer efficiency of greater than 90%, and an energy loss of less than 10%.

3. The active battery management system of claim 1, wherein each of the energy transfer units is a DC-DC converter comprising a discharge type energy transfer control and a charge type energy transfer control, and wherein the discharge type energy transfer control actively transfers excessive energy from the underperforming battery cell to the remaining cells in a battery pack as an integrated unit, and the charge type energy transfer control actively transfers energy from the remaining battery cells in a battery pack as an integrated unit into an underperforming battery cell.

4. The active battery management system of claim 1, wherein the synchronized voltage monitors read the voltages of the battery cells simultaneously, and the voltage differential AV between the battery cells are not affected by the transient electromagnetic interference.
